(19) United States
(12) Patent Application Publication
(10) Pub. No.: US 2021/0360910 A1
(43) Pub. Date: Nov. 25, 2021

(54) Tick Removing Devices and Methods

(71) Applicant: Yacht Blox LLC, Shelter Island Heights, NY (US)

(72) Inventors: Frederick Peter Brechter, Shelter Island, NY (US); Stefan Christian Brechter, Shelter Island, NY (US)

(21) Appl. No.: 17/324,783

(22) Filed: May 19, 2021

Related U.S. Application Data
(60) Provisional application No. 63/027,575, filed on May 20, 2020.

(51) Int. Cl. A01M 1/14

(52) U.S. Cl. CPC A01M 1/14

(57) ABSTRACT

Aspects of the disclosure relate to a tick remover device. The device may be configured to remove ticks from the skin or hair of humans. The device may be disposable. The device may include fabric or cloth, which may be coated and/or infused with an adhesive material, such as one or more resin materials. The adhesive material may have an adhesive strength sufficient to adhere any ticks present on the skin, but an adhesive strength low enough to allow passing the device over an area of skin without discomfort for the user/subject. Some aspects relate to methods of tick removal, including use of an adhesive cloth material rubbed over an area of skin to adhere and remove any ticks, including nymph ticks.

### RELATED APPLICATIONS

This application claims priority to U.S. Provisional Patent Application No. 63/027,575 filed May 20, 2020, which is incorporated by reference in its entirety herein.

### TECHNICAL FIELD

This disclosure relates to the field of tick removers and methods of tick bite prevention. The disclosure particularly relates to devices and/or methods which readily remove ticks from humans prior to engorgement, which can prevent the spread of disease.

### BACKGROUND

The transmission of disease from tick to human takes place after the tick has engorged itself in the skin of the human. This makes removal of a tick prior to engorgement a key factor in preventing disease. Ticks generally jump onto a human from low grasses and plants, landing in the vicinity of the feet, ankles or lower leg. Prior to engorging itself, a tick is generally found perambulating in an upward direction along the legs and/or trunk of the human where they are seeking soft warm skin that is easier to pierce. Ticks can cause infection, making detection and/or removal important.

### SUMMARY

This Summary provides an introduction to some general concepts relating to this disclosure in a simplified form, where the general concepts are further described below in the Detailed Description. This Summary is not intended to identify key features or essential features of the disclosure.

In some aspects, a tick removing device is disclosed. The device may include a cloth, such as a cheese cloth, and may provide a towelette. In some examples, a towelette may be infused with one or more substances to make the cloth material tacky and/or sticky. In some examples, a resin may be used to impart tackiness. The towelette may manipulated by hand and moved across the surface of human skin or hair to remove ticks and/or other microscopic insects from the surface.

In some examples, the device is a towelette. The towelette may be a sticky cloth that the user passes over the skin immediately following potential exposure to ticks in order to remove any tick or other insect, regardless of whether a tick or insect is large enough to be viewed by the naked eye. The towelette removes any ticks present and is then disposed in a trash receptacle. The towelette may be sealed in a container prior to disposal.

In other examples, tick removing methods applying the above concepts are disclosed.

These and other features, advantages, and objects of the present disclosure will be further understood and appreciated by those skilled in the art by reference to the following specification, claims, and appended drawings, where various embodiments of the design illustrate how concepts of this disclosure may be used.

### BRIEF DESCRIPTION OF THE DRAWINGS

The present disclosure is illustrated by way of example and not limited in the accompanying figures in which like reference numerals indicate similar elements and in which:

FIG. 1 shows an illustrative view of a tick removing device stored in a container according to aspects described herein;

FIG. 2 shows an illustrative view of a tick removing device being prepared for use according to aspects described herein;

FIG. 3 shows an illustrative use of a tick removing device according to aspects described herein;

FIG. 4 shows an illustrative use of the tick removing device according to aspects described herein; and

FIG. 5 shows an illustrative view of the tick removing device after use and according to aspects described herein.

### DETAILED DESCRIPTION

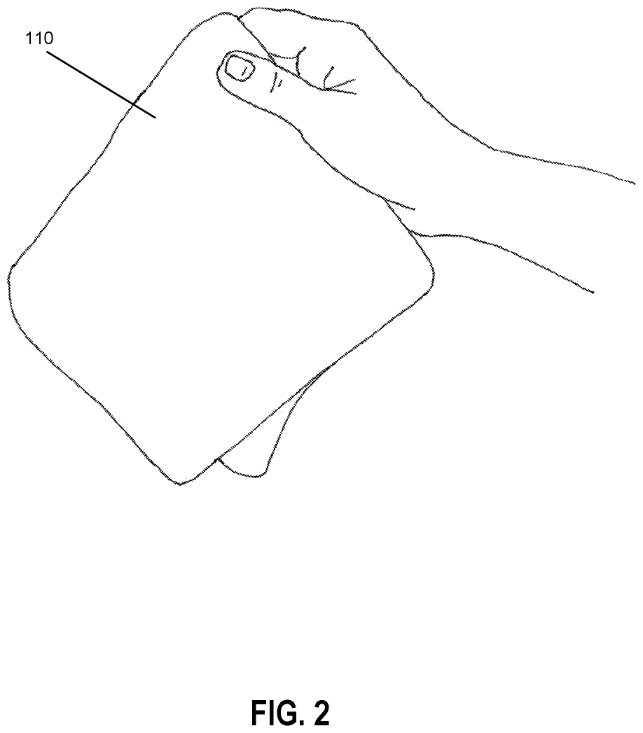

In some aspects of the invention, a tick removing device 110 is disclosed, as shown in FIGS. 2-5. The tick removing device 110 may include a fabric. The fabric may be in the form of a towelette. In some examples, the fabric includes or consists of a woven and/or non-woven material. The fabric may include or consist of natural materials, such as cotton and/or silk, and/or synthetic materials such as polyester, rayon, and so on, or combinations thereof. In some examples, the fabric provides a towelette made from a standard bleached cotton cheese cloth of any grade. In some examples, the fabric may be entirely or partially bleached, colored, dyed, pigmented, and/or combinations therefore, and may include additional materials such as patches or printed instruction material, where the additional materials may be on or near the edge of the fabric to provide a relatively large wiping surface on the fabric interior.

The fabric may include one or more additives. The additives may be coated on at least a portion of the fabric, infused into at least a portion of the fabric, or both. In some examples, all of the fabric contains one or more additives. The one or more additives may include an adhesive material. The adhesive material may be, include, and/or be a derivative of an elastomer, hydrogel, wax, and/or resin material, or a combination thereof. The adhesive material(s) may include and/or consistent of natural substantives, synthetic substances, or a combination thereof, although in some examples the adhesive material(s) and/or additive(s) are all natural materials. Specific examples include but are not limited to silicones, vinyl alcohol compounds such as vinyl alcohol hydrogels, natural waxes such as beeswax, synthetic waxes, hydrocarbon waxes such as polyethylene waxes and/or hydrocarbon based waxes that have been functionalized through the addition of a functional group such as an ether or halogen group, and/or wax esters, gums such as plant gums (e.g. acacia gum), starches, glues, and plant resins such as pine resins, oleoresins, gum resins, oils such as plant oils, petroleum based compounds, and/or combinations thereof. The one or more additives may also include one or more insecticides, fragrances, oils, and combinations thereof. For example, in some embodiments, a natural oil is added, such as eucalyptus oil, that may provide insect repellant and/or deterrent characteristics. In some embodiments, other synthetic insecticides may be used, such as DEET.

The fabric, e.g., cheese cloth, may be infused with resin and/or coated with a resin material, and/or a wax material, and/or a combination thereof. The adhesive material(s) may provide a lightly adhesive quality to the fabric. In some examples, the adhesive materials and (if present) any other additives, may provide an adhesion between the fabric and a user's skin and/or hair when the fabric is passed over the skin and/or hair or otherwise placed into contact with the hair. In some examples, the adhesive material(s) provides an adhesive strength between the fabric and a user (e.g. the user's skin and/or hair, such as when the fabric is placed into contact with the user's leg) where the lap shear strength (i.e. the strength corresponding to the force needed to draw the fabric across the skin, as when, for example, a user could do when placing the fabric in contact with the skin, and then moving the fabric laterally across to an adjacent area of their leg) is about 5 MPA or less, about 4 MPa or less, about 3 MPa of less, about 2 MPa or less, about 1.75 MPa or less, about 1.5 MPa or less, about 1.25 MPa or less, about 1 MPa or less, about 0.9 MPa or less, about 0.8 MPa or less, about 0.7 MPa or less, about 0.6 MPa or less, or about 0.5 MPa or less. In some examples, the adhesive material(s) provides an adhesive strength between the fabric and a user where the lap shear is about 0-1 MPa, about 0.5-1.5 Mpa, about 0.5-2 MPa, about 0.75-1.25 MPa, about 0.5-1.0 MPa, about 0-2 MPa, about 0-0.75 MPa, or about 0-3 MPa. In some examples, the adhesive material(s) provides an adhesive strength between the fabric and a user where the fabric/skin lap shear is about 3 MPa or more, about 2 MPa or more, about 1.75 MPa or more, about 1.5 MPa or more, about 1.25 MPa or more, about 1 MPa or more, about 0.9 MPa or more, about 0.8 MPa or more, about 0.7 MPa or more, about 0.6 MPa or more, or about 0.5 MPa or more. The fabric/skin lap shear values provided here are determined using a modified version of ASTM F2255-05(2015), Standard Test Method for Strength Properties of Tissue Adhesives in Lap-Shear by Tension Loading, ASTM International, West Conshohocken, Pa., 2015, www.astm.org, where the adhesive is placed between a skin sample and a fabric sample (rather than two skin samples). In some examples, the adhesive material(s) provides an adhesive strength where the standard lap shear is any of the values discussed above (or others) where the standard lap shear strength is determined via a standard version of ASTM F2255-05(2015), Standard Test Method for Strength Properties of Tissue Adhesives in Lap-Shear by Tension Loading, ASTM international, West Conshohocken, Pa., 2015, www.astm.org.

In some examples, although the fabric (e.g. towelette) is somewhat sticky and has an adhesive quality, it can still be easily drawn across the skin or hair by selection of adhesive material(s) (and, if they would influence adhesive strength, any other additives) for the fabric type. At the same time, there is still sufficient adhesion such that any ticks, including microscopic nymph ticks invisible to the naked eye, may be removed. The fabric may be rectangular, square, circular, elliptical, and/or any other geometric or non-geometric shape.

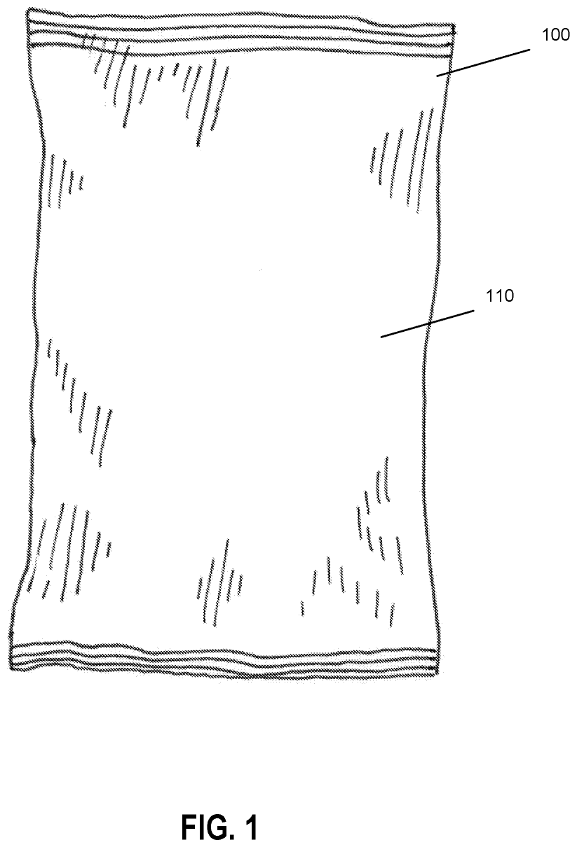

In some examples, the fabric, e.g. towelette, is supplied in a container 100, as shown in FIG. 1. The container 100 may enclose the tick removing device 110. For example, a sealed air tight plastic bag (e.g. a crimped, clear, plastic bag) may be used, allowing the fabric to retain its tacky or sticky quality and further allowing it to be shipped, transferred or carried without sticking to the users hand, pocket or surroundings. Other airtight or nearly airtight containers may also be used. Other materials may also be selected, e.g. metal, containers of different materials with gaskets/seals, unsealed containers with additional materials that provide moisture in the ambient air inside the container 100, and so on. In some examples, a fabric or other sheet material is provided on a roller, or a component directly and/indirectly coupled to a roller and/or other rotating component, with one or more additives added onto (coated, infused, etc.) the sheet. For such examples, a user may roll the fabric and/or sheet over their skin, which will place new areas of the sheet into contact with new areas of skin, thus efficiently removing ticks in a wide area.

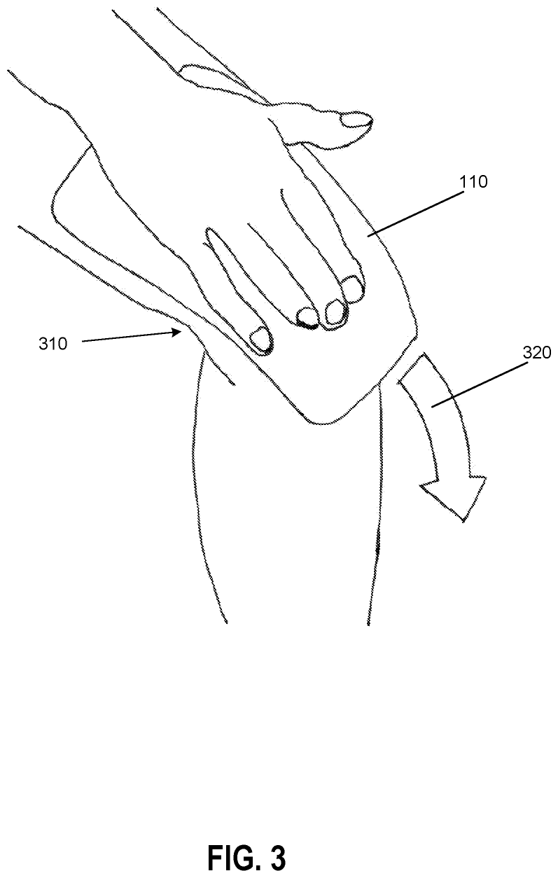

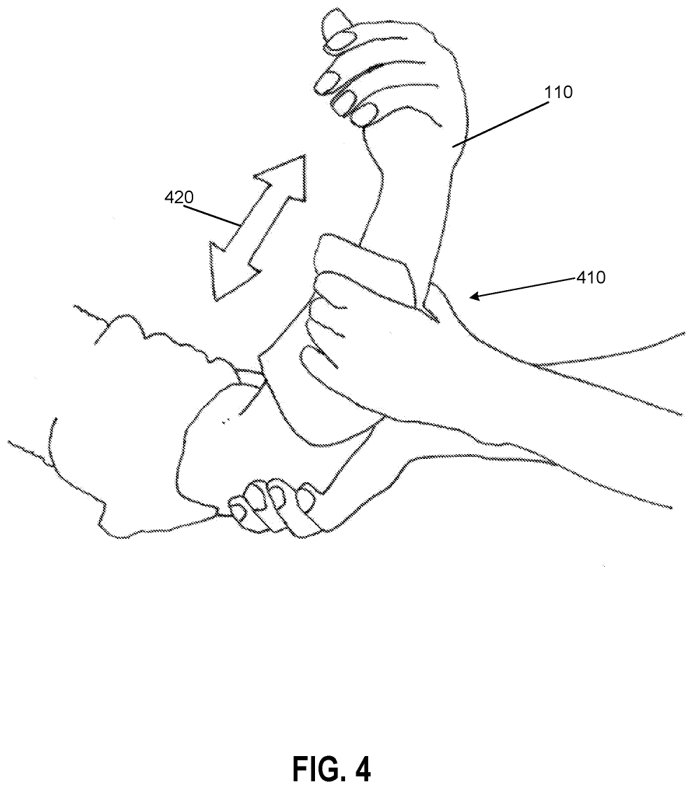

In some aspects, methods of tick removal are disclosed, as shown in FIGS. 3 and 4. Any aspects of the tick removing device 110 embodiments may apply to the method examples, and any aspects described in connection with method embodiments may be applied to the tick removing device 110. In some examples, the container 100 (e.g. a plastic bag) is opened by the user and a towelette is removed and unfolded (the fabric may also be stored in an unfolded orientation at the outset, for example to avoid self-adhesion). In these examples, by placing the towelette in the palm of the hand, the user is able to move it, e.g., motion 320, motion 420, across the surface of the skin, dab it onto a specific area of skin, both, and/or otherwise bring the fabric into contact with one or more areas of skin. In some examples, another person, may apply the fabric. The fabric may be dabbed, rubbed back and forth, drawn in a single direction, any combinations thereof, or applied in any other ways resulting in contact. The application may be to any area of skin, including but not limited to one or more of a user's feet, legs, torso, hands, arms, neck or head, and/or any areas and/or parts of the same (e.g. elbow, knee, forearm, shin, etc.). The tacky or sticky quality of the cloth may create an adhesive bond between the cloth and anything on the surface of the skin.

This adhesive bond may ensure that any tick or insect seen or unseen on the skin becomes bonded or attached to the cloth and removed from the surface of the skin. Humans are often infected through bites of immature ticks called nymphs. Nymphs are tiny (e.g, less than 2 mm) and difficult to see. Thus, visual inspection alone may be insufficient, but relatively prompt use of the methods/device may eliminate all ticks easily. While ticks may be removed after any time period, removing ticks before they bite the subject facilitates earlier removal.

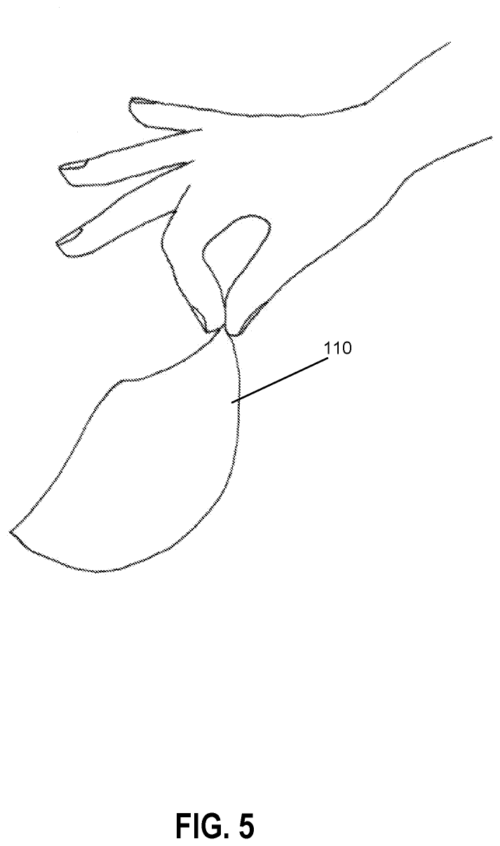

The user may wipe down the surface of a body part, such as at a position 310 or a position 410, the body part may include their legs, arms, and/or another body part after outdoor activities and then dispose of the towelette. Ticks and other microscopic insects attached to the towelette will remain attached to it and immobilized, eventually perishing from lack of nutrition and the inability to move. As shown in FIG. 5, the towelette/fabric may be disposed of, e.g. thrown away, to dispose of any adhered ticks. Any container 100, e.g., a plastic bag, may be resealable to accept and re-enclose the used towelette to facilitate disposal and/or help ensure any ticks do not escape.

Additional specific examples of the disclosure include the following: a tick remover (e.g., the tick removing device 110) contained in an airtight plastic bag (e.g., the container 100) for convenient deployment on the skin and hair of humans; a tick remover employing beached or unbleached cheese cloth; a tick remover employing cheese cloth made from either cotton or synthetic thread; a tick remover employing cheese cloth of any grade such as but not limited to #10, #20, #40, #50, #60, #80 or #90 grades; a tick remover employing any grade of cheese cloth infused with resin or light adhesive of any type—to include petroleum based and non-petroleum based resins, and/or other forms of adhesives; a tick remover which is drawn across the skin or hair manually by the hand, e.g., a motion 320, a motion 420; a tick remover that attaches itself to the tick by the process of adhesion; a tick remover which can adhere to multiple ticks simultaneously; a tick remover that can remove ticks that are invisible to the naked eye (e.g., microscopic); a tick remover that can adhere to both visible and invisible ticks simultaneously such that multiple ticks can be removed in a short period of time (e.g., less than a minute, under thirty seconds, etc.); a tick remover which adheres to any tick or ticks that it comes into contact with and allows the user to remove said tick or ticks from the surface of the body or hair; and a tick remover that allows the user to permanently dispose of any tick removed from the body or hair by disposing of the tick remover itself.

Still other examples of the disclosure include, but are not limited to, the content of the following claims.

We claim:

1. A tick remover device comprising: a fabric and one or more additives, and wherein the one or more additives comprise an adhesive material.

2. The device of claim 1, further comprising a container enclosing the device.

3. The device of claim 2, wherein the container is an airtight plastic bag.

4. The device of claim 1, wherein the fabric comprises cheese cloth material.

5. The device of claim 1, wherein the fabric comprises cotton material, synthetic material, or both.

6. The device of claim 1, wherein the adhesive material comprises one or more resins, waxes, gums, elastomers, hydrogels, or a combination thereof The device of claim 6, wherein the adhesive material is non-synthetic.

8. The device of claim 6, wherein the adhesive material comprises one or more petroleum- based materials.

9. The device of claim 1, wherein the adhesive material has an adhesive strength sufficient to adhere to any tick that is placed into contact with an area of the fabric containing the adhesive material.

10. The device of claim 9, wherein the adhesive strength is sufficient to adhere to nymph ticks.

11. The device of claim 1, wherein the adhesive material has an adhesive strength low enough that an area of the fabric containing the adhesive material is capable of being drawn across a subject's skin, hair, or skin and hair, without strongly adhering to the subject.

12. The device of claim 1, wherein the adhesive material comprises beeswax.

13. A method of removing ticks from the skin or hair of humans, the method comprising drawing an adhesive fabric material across the skin of a subject, or hair of a subject, or both.

14. The method of claim 13, wherein the adhesive fabric material comprises a fabric and one or more additives, wherein the one or more additives are coated on at least a portion of the fabric, infused into at least a portion of the fabric, or both, and wherein the one or more additives comprise an adhesive material.

15. The method of claim 13, wherein the adhesive fabric material attaches to any ticks on skin of a subject, hair of a subject, or both, by adhesion.

16. The method of claim 13, wherein multiple ticks are removed simultaneously.

17. The method of claim 13, wherein multiple ticks are removed in one minute or less.

18. The method of claim 13, wherein ticks that are invisible to the naked eye are removed.

19. The method of claim 13, further comprising disposing any ticks removed from the subject by disposing of the adhesive fabric material.

20. The method of claim 13, further comprising removing the fabric material from an airtight container prior to drawing the material.
